(19) United States
(12) Patent Application Publication
(10) Pub. No.: US 2025/0080306 A1
(43) Pub. Date: Mar. 6, 2025

(54) SRS ANTENNA SWITCHING INTERFERENCE MITIGATION

(71) Applicant: Apple Inc., Cupertino, CA (US)

(72) Inventors: Vijay Venkataraman, San Jose, CA (US); Pranav Tripathi, San Jose, CA (US); Han Pu, Shanghai (CN); Bin Feng, Beijing (CN); Dhiraj J. Shirke, San Jose, CA (US); Sanjeevi Balasubramanian, San Jose, CA (US); ChunLei Lin, NT (HK); Yu Wu, Beijing (CN)

(21) Appl. No.: 18/241,823

(22) Filed: Sep. 1, 2023

(51) Int. Cl. H04L 5/00

(52) U.S. Cl. CPC H04L 5/006; H04L 5/0048

(57) ABSTRACT

Techniques described herein includes solutions for mitigating interference related to antenna switching. A user equipment (UE) may determine a potential for interference to data reception on a second frequency band due to antenna switching associated with transmission of reference signals on a first frequency band. In response to the determination, the UE may select one or more interference mitigation measures based on an operating mode of the UE and one or more UE parameters. An interference mitigation measure may include backing off on a reported value, such as a channel quality indicator (CQI), rank indicator (RI), or reference signal received power (RSRP). The interference mitigation measure may further include skipping reference signal transmission on the first frequency band and the antenna switching associated therewith.

### FIELD

This disclosure relates to wireless communication networks including techniques for reducing receive (Rx) interference within wireless networks.

### BACKGROUND

Wireless communication networks may include user equipments (UEs), base stations, and/or other types of wireless devices capable of communicating with one another. During operation, a UE may transmit sounding reference signals (SRS) to a base station, which may be used by the base station to perform channel estimation.

### BRIEF DESCRIPTION OF THE DRAWINGS

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

FIG. 1 is a block diagram illustrating a wireless network including a user equipment (UE) and a base station configured to perform interference mitigation measures in accordance with some aspects of the present disclosure.

FIG. 2 is a schematic diagram illustrating an interference scenario in accordance with some aspects of the present disclosure.

FIG. 3 is a schematic diagram illustrating signaling between a base station and a UE configured to perform an interference mitigation measure in accordance with some aspects of the present disclosure.

FIG. 4 is a logic flow for a UE to select one or more interference mitigation measures in accordance with some aspects of the present disclosure.

FIG. 5 is a process flow for a UE to perform latency and reliability focused interference mitigation in accordance with some aspects of the present disclosure.

FIG. 6 is a schematic diagram illustrating latency and reliability focused interference mitigation measures in accordance with some aspects of the present disclosure.

FIG. 7 is a schematic diagram illustrating a reported channel quality indicator (CQI) value in accordance with some aspects of the present disclosure.

FIG. 8 is a process flow for a UE to perform downlink (DL) throughput focused interference mitigation in accordance with some aspects of the present disclosure.

FIG. 9 is a schematic diagram illustrating DL throughput focused interference mitigation measures in accordance with some aspects of the present disclosure.

FIG. 10 is a process flow for a UE to perform uplink (UL) throughput focused interference mitigation in accordance with some aspects of the present disclosure.

FIG. 11 is a schematic diagram illustrating UL throughput focused interference mitigation measures in accordance with some aspects of the present disclosure.

FIG. 12 is a schematic diagram illustrating signaling between a UE and a base station including reporting an adaptive rank indicator (RI) value for interference mitigation in accordance with some aspects of the present disclosure.

FIG. 13 is a schematic diagram illustrating signaling between a UE and a base station, including reporting UE assistance information (UAI) for interference mitigation in accordance with some aspects of the present disclosure.

FIG. 14 illustrates an example of an information element (IE) that may be included in the UAI of FIG. 13.

FIG. 15 is a schematic diagram illustrating reference signal received power (RSRP) threshold values in accordance with some aspects of the present disclosure.

FIGS. 16-17 are process flows for UEs configured to perform interference mitigation measures in accordance with some aspects of the present disclosure.

FIG. 18 is a process flow for a base station to perform smart slot scheduling for interference mitigation in accordance with some aspects of the present disclosure.

FIG. 19 is a block diagram illustrating a device that can be employed to perform interference mitigation measures in accordance with some aspects of the present disclosure.

FIG. 20 is a block diagram illustrating baseband circuitry that can be employed to perform interference mitigation measures in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Within a wireless network, a user equipment (UE) and a base station may communicate by exchanging signaling. For example, the UE may transmit uplink (UL) signals to the base station, or receive downlink (DL) signals from the base station. In order to perform channel measurement and optimize resources and schemes for signal communication accordingly, the base station may configure the UE to transmit reference signals in the UL direction. For example, the UE may be configured to transmit sounding reference signals (SRS), which may be used by the base station to measure the UL channel. The base station can also estimate the DL channel using SRS when channel reciprocity exists, such as if the UE transmits the SRS using each of its receive (Rx) antennas. In some examples, the UE may have more Rx antennas than transmit (Tx) paths. In such examples, the UE may be capable of “switching” a transmit path between multiple Rx antennas, which may be referred to as antenna switching. By performing antenna switching, the UE can transmit SRS using each of its Rx antennas, even when the number of Rx antennas exceeds the number of Tx paths, which facilitates complete estimation of the DL channel at the base station side.

In order to increase efficiency and throughput, the UE may be configured to communicate using multiple frequency bands simultaneously. For example, the UE may be configured to transmit/receive on multiple component carriers (CCs) using carrier aggregation (CA). In certain scenarios, the UE may be configured to perform antenna switching to transmit SRS on a first CC. However, such antenna switching can interfere with data reception on a second CC if slots for the SRS transmission on the first CC and the data reception on the second CC overlap with one another. Thus, interference mitigation measures to reduce interference caused by SRS antenna switching are desired.

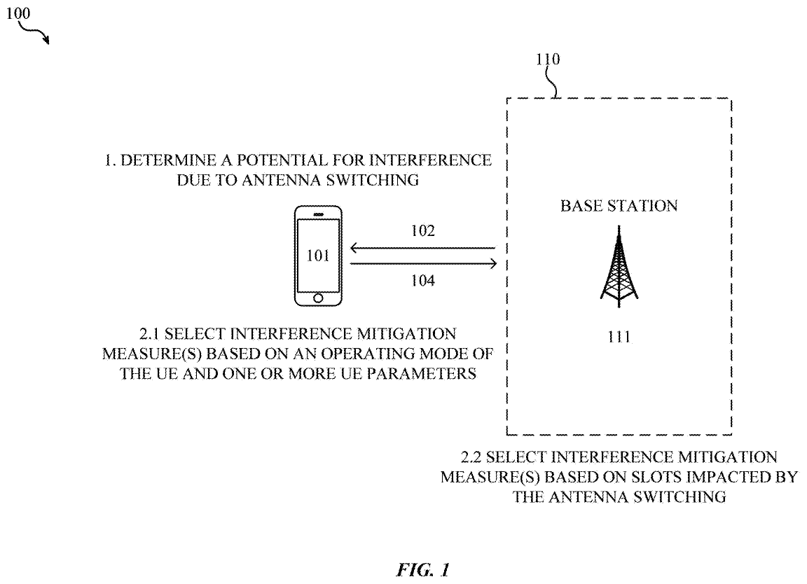

Accordingly, some aspects of the present disclosure relate to reducing interference at the slot level due to SRS antenna switching based on current UE conditions. In some aspects, an interference mitigation measure is performed by the UE based on an operating mode of the UE and/or one or more UE parameters. In some alternative aspects, the UE indicates the slots impacted by SRS antenna switching to the base station, and the base station performs slot-level smart scheduling based on the indicated slots. Further details will now be described with reference to FIG. 1.

FIG. 1 is a block diagram illustrating an example wireless network 100 in accordance with some aspects of the present disclosure. The wireless network 100 includes one or more UEs 101, and a radio access network (RAN) 110. The RAN 110 includes one or more base stations 111. The UE 101 may communicate with the base station 111 using channels 102 and 104 for UL and DL respectively.

The UEs 101 may comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

The RAN 110 may be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system, and the term “E-UTRAN” or the like can refer to a RAN 110 that operates in an LTE or 4G system.

In some aspects, the UE 101 is configured to transmit SRS to the base station 111. The UE 101 may be configured to perform antenna switching in order to transmit the SRS, for example, if a number of Rx antennas of the UE 101 exceeds a number of Tx paths of the UE 101. Although the example of SRS is used with reference to FIG. 1, other types of reference signals may also be used.

As illustrated by step 1, the UE 101 may determine a potential for interference due to the antenna switching. For example, the UE 101 may determine the potential for interference in response to antenna switching being configured and an active band combination being impacted by the antenna switching. The active band combination may include a first frequency band for transmitting SRS, and a second frequency band for receiving DL data. The antenna switching associated with the SRS transmission on the first frequency band may cause interference to DL reception during overlapping slots on the second frequency band.

In some aspects, as illustrated by step 2.1, one or more interference mitigation measures are performed by the UE 101. As shown, the UE 101 may select one or more interference mitigation measures based on an operating mode of the UE 101 and one or more UE parameters. An operating mode of the UE 101, for example, may include a DL throughput centric operating mode, an UL throughput centric operating mode, a low latency operating mode, and/or a high reliability operating mode. A UE parameter, for example, may include a block error rate (BLER) of a DL channel, a predicted SRS transmit power, a channel state information (CSI) configuration for a frequency band used to transmit the SRS, a precoding matrix indicator (PMI) configuration for the frequency band used to transmit the SRS, or a percentage of total bandwidth impacted by the interference.

In some aspects, the one or more interference mitigation measures performed by the UE 101 include skipping an SRS transmission, backing off on a reported channel quality indicator (CQI) value, backing off a reported rank indicator (RI) value, reporting a minimum CQI value, and/or reporting a minimum reference signal received power (RSRP) value. For example, the UE 101 may skip an SRS transmission on the first frequency band in order to reduce the interference to data reception on the second frequency band during the overlapping slot(s). The UE 101 may back off an a reported CQI and/or RI value for the second frequency band, which may cause the base station 111 to utilize a lower modulation and coding scheme (MCS) for the second frequency band in order to reduce BLER by increasing coding redundancy. Alternatively, the UE 101 may report a minimum CQI and/or RSRP value for the second frequency band, which may cause the base station 111 to release the second frequency band. After releasing the second frequency band, the UE 101 and the base station 111 may communicate using the first frequency band.

In some aspects, as illustrated by step 2.2, one or more interference mitigation measures are performed by the base station 111. As shown, the base station 111 may select one or more interference mitigation measures based on slots impacted by the antenna switching. The slots impacted by the antenna switching, for example, may be indicated to the base station 111 by the UE 101.

In some aspects, the one or more interference mitigation measures performed by the base station 111 include scheduling a lower number of layers during the impacted slots, scheduling preferred layers during the impacted slots, or skipping scheduling during the impacted slots. For example, the base station 111 and the UE 101 may be configured to communicate using multiple-input multiple-output (MIMO). A “layer” may refer to a data stream to be used for MIMO communication. In some examples, in order to mitigate interference, the base station 111 schedules a lower number MIMO layers during the impacted slots. Alternatively, the base station 111 may schedule preferred MIMO layer(s) during the impacted slots. The preferred MIMO layer(s), for example, may be indicated to the base station 111 by the UE 101. In another example, the base station avoids scheduling the impacted slots and instead schedules the non-impacted slots.

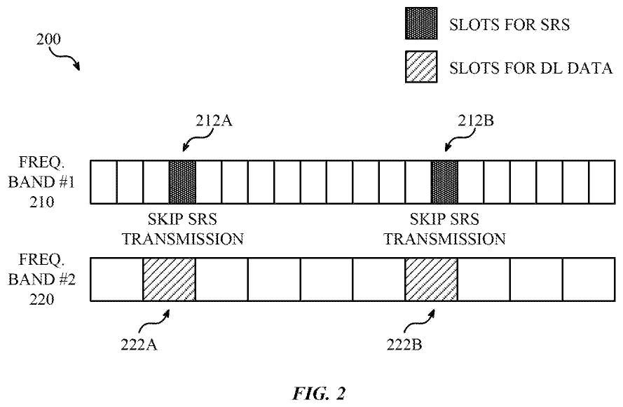

FIG. 2 is schematic diagram illustrating an example interference scenario in accordance with some aspects of the present disclosure. Illustrated is a frequency band combination 200 including a first frequency band 210 and a second frequency band 220. In the example of FIG. 2, a slot duration on the first frequency band 210 is equal to half a slot duration on the second frequency band 220. For example, the first frequency band 210 and the second frequency band 220 may have different numerologies, resulting in different slot durations. Although not shown, in alternative examples the slot duration on the frequency band 210 may be equal to or greater than the slot duration on the frequency band 220.

In some aspects, the frequency band combination 200 is impacted by antenna switching. For example, a UE (e.g., UE 101) is configured to transmit SRS during a first slot 212A and a second slot 212B on the first frequency band 210. The UE may be configured to perform antenna switching in order to transmit the SRS, which causes interference during a third slot 222A and a fourth slot 222B on the second frequency band 220. As shown, the third slot 222A and the fourth slot 222B may be scheduled for DL data. The DL data may be received, for example, from a base station (e.g., base station 111) on a physical downlink shared channel (PDSCH).

In some aspects, the UE mitigates interference by skipping an SRS transmission. As shown, the UE may avoid transmitting SRS during the slots 212A, 212B, which overlap the slots 222A, 222B that are scheduled for DL data. By skipping SRS transmissions during the slots 212A, 212B, no antenna switching is performed. Therefore, antenna switching related interference is mitigated with respect to the slots 222A, 222B. Furthermore, since SRS transmission is skipped, the SRS Tx power is saved. The saved power could be reallocated/utilized to increase uplink control information (UCI) Tx power (e.g., to improve UCI signal strength) without increasing the total Tx power budget.

In some examples, the first frequency band 210 is a time division duplex (TDD) band, and the second frequency band 220 is a frequency division duplex (FDD) band. The first frequency band 210 may correspond to a primary component carrier (PCC), and the second frequency band 220 may correspond to a secondary component carrier (SCC). The UE may be configured to communicate with a base station (e.g., base station 111) on the frequency bands 210, 220 using carrier aggregation (CA).

As described with reference to FIG. 1, the UE may gradually back off an a reported CQI and/or RI value for the second frequency band 220. In response, to receiving a lower CQI and/or RI value, the base station may allocate a lower MCS for the second frequency band 220. The lower MCS may reduce BLER on the second frequency band 220 in the presence of antenna switching related to SRS transmission on the first frequency band 210. Alternatively, the UE may report a minimum CQI and/or RSRP value for the second frequency band 220, which may cause the base station to release the second frequency band 220, corresponding to the SCC. Since the SCC is not essential for communication, the UE and the base station may continue communicating using the PCC (e.g., frequency band 210).

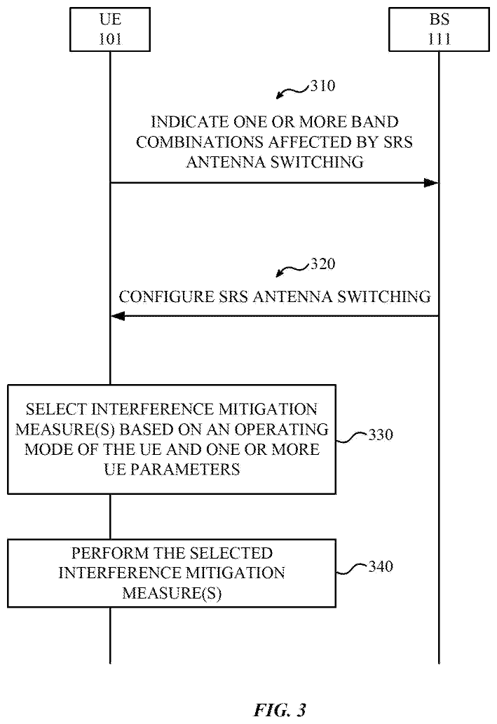

FIG. 3 is a schematic diagram illustrating an example of signaling between a base station 111 and a UE 101. In the example of FIG. 3, the UE 101 is configured to perform one or more interference mitigation measures, as described throughout the present disclosure.

At act 310, the UE 101 indicates one or more band combinations impacted by SRS antenna switching to the base station 111. For example, the UE 101 may transmit UE capability information to the base station 111, where the UE capability information includes an information element (IE), e.g., t&SwitchImpactToRx indicating the impacted band combinations.

At act 320, the base station 111 configures the UE 101 to perform SRS antenna switching. For example, the base station 111 may transmit a radio resource control (RRC) reconfiguration message to the UE 101 to configure the SRS antenna switching.

At act 330, the UE 101 selects one or more interference mitigation measures based on an operating mode of the UE 101 and one or more UE parameters. The one or more interference mitigation measures may include skipping an SRS transmission, backing off on a reported channel quality indicator (CQI) value, backing off a reported rank indicator (RI) value, reporting a minimum CQI value, and/or reporting a minimum RSRP value, as previously described.

At act 340, the UE performs the one or more selected interference mitigation measures.

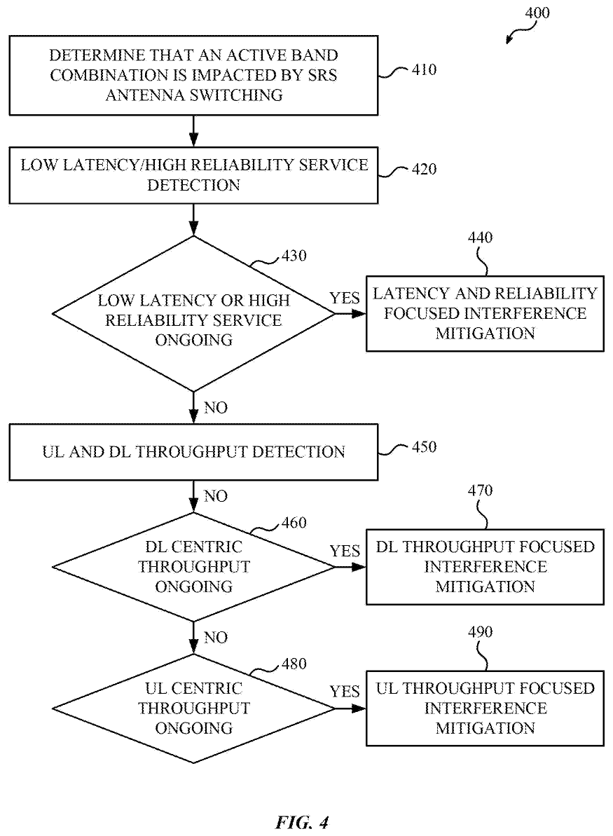

FIG. 4 illustrates an example logic flow 400 for a UE to select one or more interference mitigation measures. In some examples, the logic flow 400 represents act 330 and/or act 340 of FIG. 3. The logic flow 400 may be performed by the UE 101, as described throughout the present disclosure.

At act 410, the UE determines that an active band combination is impacted by SRS antenna switching. For example, the UE may determine that the active band combination is impacted in response to the active band combination being included in an IE txSwitchImpactToRx in UE capability information (e.g., from act 310 of FIG. 3).

At act 420, the UE performs low latency and/or high reliability service detection. In some examples, a low latency/high reliability service includes an Ultra-Reliable Low Latency Communications (URLLC) service. In some examples, the UE detects low latency or high reliability service by evaluating one or more of: a 5G quality of service (QoS) identifier (5QI), an RRC configuration, a physical layer of the UE, and an application layer of the UE.

In some aspects, evaluating the 5QI includes evaluating a packet delay budget and/or a packet error rate. For example, the UE may determine that low latency/high reliability service is ongoing in response to a packet delay budget being less than a threshold value (e.g., 100 ms), and/or packet error rate being less than a threshold value (e.g., 10⁻⁶). In some examples, the UE determines whether low latency/high reliability service is ongoing by comparing a configured 5QI value or a QoS flow identifier (QFI) value to a set of known low latency/high reliability related 5QI or QFI values.

In some aspects, evaluating the RRC configuration includes evaluating a configured UL grant, a bandwidth part (BWP) configured slot length, a duplicated packet data convergence protocol (PDCP), a low spectral efficiency MCS table, and/or a configured slot repetition. For example, the UE may determine that low latency/high reliability service is ongoing in response to detecting that a configured grant (CG) is configured, a duplicated PDCP is configured, a low spectral efficiency MCS table is configured, and/or slot repetition is configured. Furthermore, the UE may determine that low latency/high reliability service is ongoing in response to detecting a shorter slot length on a specific BWP.

In some aspects, evaluating the physical layer of the UE includes evaluating for mini-slots and/or pre-emptive downlink control information (DCI). For example, if the UE detects that mini-slots are configured, and/or that pre-emptive DCI is configured, the UE may determine that low latency/high reliability service is ongoing.

In some aspects, evaluating the application layer of the UE includes evaluating for an extended reality (XR) service, a vehicle to everything (V2X) service, a low latency required flag, or a high reliability flag. The UE may determine that low latency/high reliability service is ongoing if a low latency required flag or a high reliability required flag is detected, or if an XR service or V2X service is ongoing.

At act 430 the UE determines whether low latency/high reliability service was detected at act 420. If low latency/high reliability service was detected at act 420, then the UE performs latency and reliability focused interference mitigation at act 440. Otherwise, the UE proceeds to act 450.

At act 450, the UE performs UL/DL throughput detection. In some examples, the UE evaluates a ratio between UL throughput and DL throughput in order to determine if the UE is operating in a DL centric throughput mode or an UL centric throughput mode.

At act 460, the UE determines whether DL centric throughput was detected at act 450. If DL centric throughput was detected at act 450, then the UE performs DL throughput focused interference mitigation at act 470. Otherwise, the UE proceeds to act 480.

At act 480, the UE determines whether UL centric throughput was detected at act 450. If UL centric throughput was detected at act 450, then the UE performs UL throughput focused interference mitigation at act 490.

Further details of latency and reliability focused interference mitigation, DL throughput focused interference mitigation, and UL throughput focused interference mitigation will now be described with reference to the following figures.

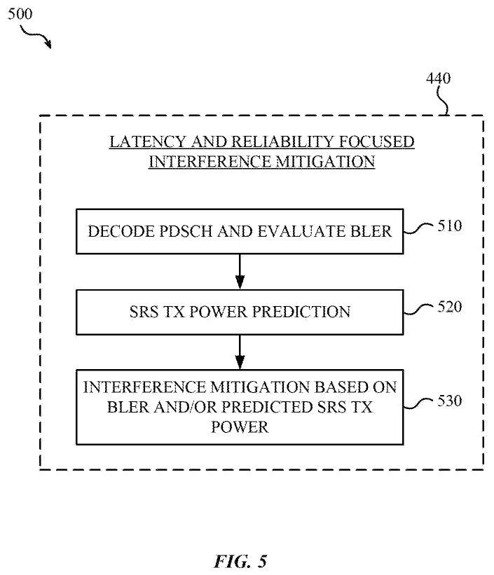

FIG. 5 illustrates an example process flow 500 for a UE to perform latency and reliability focused interference mitigation. The UE may be the UE 101, as described throughout the present disclosure. As illustrated in FIG. 5, the process flow 500 includes an example of act 440 of FIG. 4, which includes acts 510, 520, and 530.

At act 510, the UE decodes PDSCH transmissions from a base station (e.g., base station 111) and evaluates BLER. The PDSCH transmissions may be received by the UE using a second frequency band, for example, as described with reference to FIG. 2. In some examples, the BLER is evaluated based on a ratio of acknowledgement (ACK) to negative acknowledgment (NACK) messages transmitted to the base station in response to the PDSCH transmissions.

At act 520, the UE performs SRS Tx power prediction. For example, the UE may predict the SRS Tx power using the following equation:

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ]$$

P_{SRS,b,f,c}(i, q, l) is the SRS transmission power on an active UL BWP b of carrier f of serving cell c. The variable i is the SRS transmission occasion, qₛ is the SRS resource set, and l is the SRS power control adjustment state. P_{CMAX} is the maximum output power of the UE, M_{SRS} is an SRS bandwidth expressed in number of resource blocks, μ is the configured subcarrier spacing (SCS), and h is the current physical uplink shared channel (PUSCH) power control adjustment state. P_{O_SRS} and α are determined by a BWP configuration for the BWP in use for SRS transmission.

The SRS may be transmitted by the UE using a first frequency band, for example, as described with reference to FIG. 2 and throughout the present disclosure.

At act 530, the UE performs one or more interference mitigation measures based on the evaluated BLER and/or the predicted SRS Tx power.

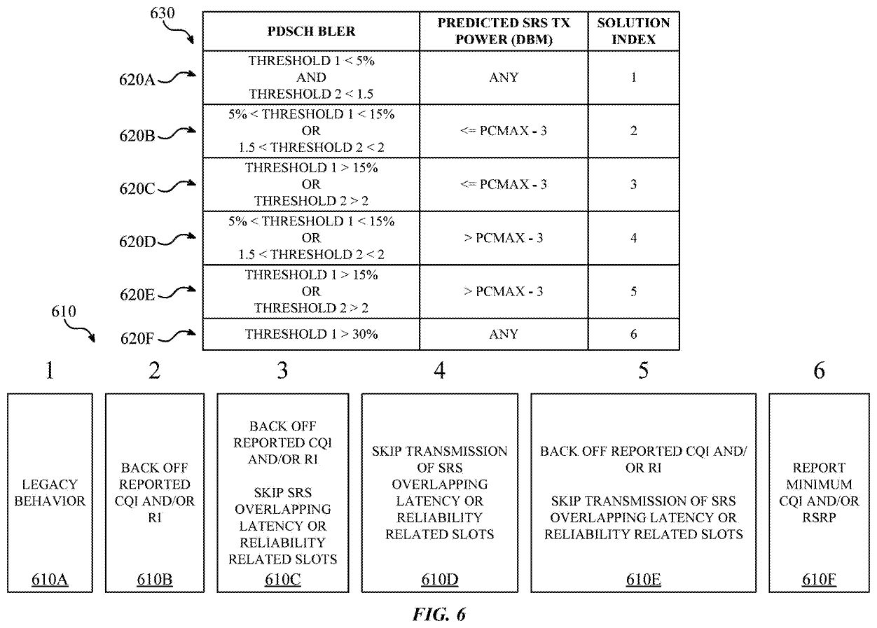

FIG. 6 is a schematic diagram illustrating an example of latency and reliability focused interference mitigation measures 610A-610F (collectively referred to as “interference mitigation measures 610”). In some aspects, one or more of the interference mitigation measures 610 are selected and/or performed by a UE (e.g., UE 101), for example, at act 530 of FIG. 5.

In some aspects, the UE selects one of the interference mitigation measures 610 based a set of conditions 620A-620F (collectively referred to as “conditions 620”) included in a condition table 630. As shown, the conditions 620 may include conditions for PDSCH BLER and/or predicted SRS Tx power. The conditions 620 may correspond to a plurality of respective solution indexes, which may each correspond to one of the interference mitigation measures 610.

In some aspects, evaluating a PDSCH BLER condition includes evaluating a first BLER threshold value, referred to as “THRESHOLD 1”, and/or a second BLER threshold value, referred to as “THRESHOLD 2”.

The first BLER threshold value may be determined based on a difference between PDSCH BLER on slots overlapping SRS transmission and PDSCH BLER on slots not overlapping SRS transmission. For example, the first BLER threshold value may be determined using the following equation:

THRESHOLD 1=BLER on overlapped slots−BLER on non-overlapped slots

The second BLER threshold value may be determined based on a ratio between PDSCH BLER on slots overlapping SRS transmission and PDSCH BLER on slots not overlapping SRS transmission. For example, the second BLER threshold value may be determined using the following equation:

THRESHOLD 2=BLER on overlapped slots/BLER on non-overlapped slots

In some aspects, evaluating the predicted SRS Tx power condition includes comparing the predicted SRS Tx power to an SRS threshold value. The SRS threshold value, for example, may be determined relative to a maximum SRS Tx power, referred to as “PCMAX”.

The interference mitigation measure 610A may include a legacy UE behavior. The interference mitigation 610A may be performed, for example, in response to the condition 620A being satisfied. As shown, the condition 620A includes the first BLER threshold being less than a first percentage value (e.g., 5%), and the second BLER threshold being less than a first scalar value (e.g., 1.5). If the condition 620A is satisfied, the UE may determine that further interference mitigation in addition to the legacy behavior is not desired.

The interference mitigation measure 610B may include backing off on a reported CQI value and/or backing off on a reported RI value, for example, as described with reference to FIGS. 1-2. The UE may back off on a reported CQI value according to a CQI backoff step size until a CQI threshold is reached. Upon reaching the CQI threshold, the UE may back off on a report RI value according to an RI backoff step size until an RI threshold is reached.

The interference mitigation measure 610B may be performed in response to the condition 620B being satisfied. As shown, the condition 620B includes the first BLER threshold being greater than the first percentage value (e.g., 5%) and less than a second percentage value (e.g., 15%), and the second BLER threshold value being greater than the first scalar value (e.g., 1.5) and less than a second scalar value (e.g., 2). Furthermore, the condition 620B includes the predicted SRS Tx power being less than or equal to a first SRS threshold value. In the illustrated example, the first SRS threshold value is equal to (PCMAX−3) decibel milliwatts (dBm).

The interference mitigation measure 610C may include backing off on a reported CQI value and/or backing off on a reported RI value, and skipping SRS transmissions overlapping latency or reliability related slots. Latency or reliability related slots may include, slots for configured DL grant, slots for slot repetition, mini-slots, and/or slots for pre-empted DL.

The interference mitigation measure 610C may be performed in response to the condition 620C being satisfied. As shown, the condition 620C includes the first BLER threshold being greater than the second percentage value (e.g., 15%), and the second BLER threshold value being greater than the second scalar value (e.g., 2). Furthermore, the condition 620C includes the predicted SRS Tx power being less than or equal to the first SRS threshold value.

The interference mitigation measure 610D may include skipping transmission of SRS overlapping latency or reliability related slots. For example, the UE may transmit SRS only during non-overlapping slots.

The interference mitigation measure 610D may be performed in response to the condition 620D being satisfied. As shown, the condition 620D includes the first BLER threshold being greater than the first percentage value (e.g., 5%) and less than the second percentage value (e.g., 15%), and the second BLER threshold value being greater than the first scalar value (e.g., 1.5) and less than the second scalar value (e.g., 2). Furthermore, the condition 620D includes the predicted SRS Tx power being greater than the first SRS threshold value.

The interference mitigation measure 610E may include backing off on a reported CQI value and/or backing off on a reported RI value, and skipping transmission of SRS overlapping latency or reliability related slots. The interference mitigation measure 610E may be performed in response to the condition 620E being satisfied. As shown, the condition 620E includes the first BLER threshold being greater than the second percentage value (e.g., 15%), and the second BLER threshold value being greater than the second scalar value (e.g., 2). Furthermore, the condition 620E includes the predicted SRS Tx power being greater than the first SRS threshold value.

The interference mitigation measure 610F may include reporting a minimum CQI value and/or reporting a minimum RSRP value, for example, as described with reference to FIGS. 1-2 and throughout the present disclosure.

The interference mitigation measure 610F may be performed in response to the condition 620F being satisfied. As shown, the condition 620F includes the first BLER threshold being greater than a third percentage value (e.g., 30%).

In some aspects, the UE evaluates the PDSCH BLER and predicted SRS Tx power conditions according to the condition table 620, and performs the interference mitigation measure corresponding to the highest solution index value for which the associated condition is satisfied. For example, if the condition for solution indexes 2 and 3 are both satisfied, the UE would perform the interference mitigation measure associated with solution index 3.

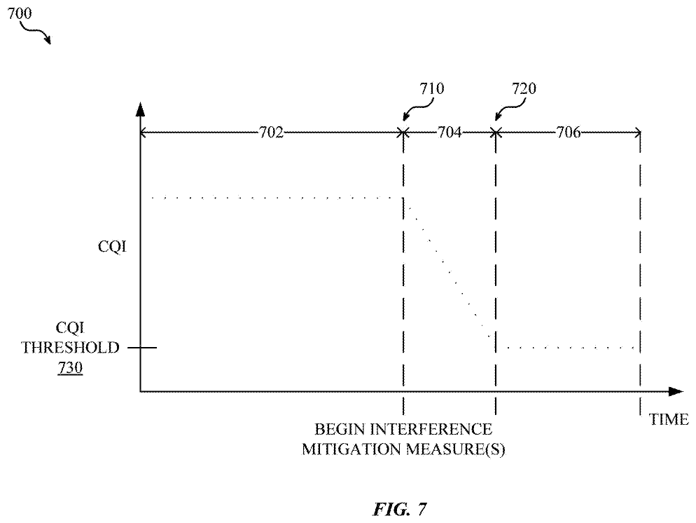

FIG. 7 is a schematic diagram illustrating an example 700 of a reported CQI value over time. The CQI value, for example, may be reported by a UE (e.g., UE 101) to a base station (e.g., base station 111).

During a first time period 702, the reported CQI value remains constant. At a first point in time 710, the UE begins interference mitigation measures. The interference mitigation measures may include backing off on the reported CQI value, as described throughout the present disclosure. Over a second time period 704, the UE backs off on the reported CQI value according to a CQI backoff step size, until a CQI threshold value 730 is reached at a second point in time 720. During a third time period 706, the UE continues to report the CQI threshold value 730. Although not shown for simplicity, the UE may follow a similar process and begin to back off on the reported RI upon reaching the CQI threshold value 730 at the second point in time 720, as described throughout the present disclosure.

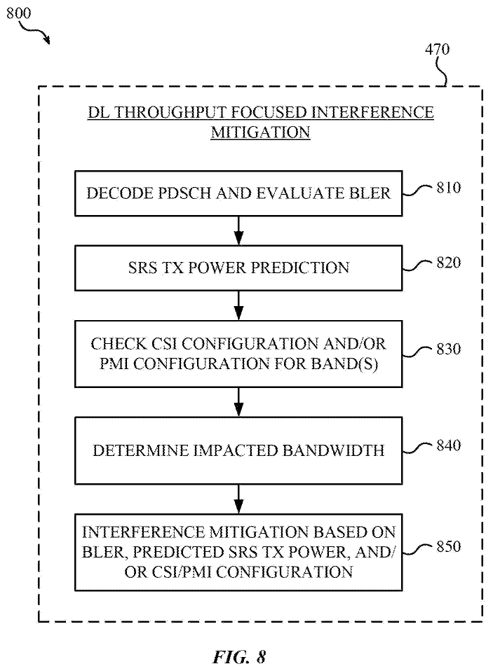

FIG. 8 illustrates an example process flow 800 for a UE (e.g., UE 101) to perform DL throughput focused interference mitigation. As illustrated in FIG. 8, the process flow 800 includes an example of act 470 of FIG. 4, which includes acts 810, 820, 830, and 840.

At act 810, the UE decodes PDSCH transmissions from a base station (e.g., base station 111) and evaluates BLER. The PDSCH transmissions may be received by the UE using a second frequency band, for example, as described with reference to FIG. 2. In some examples, the BLER is evaluated based on a ratio of ACK to NACK messages transmitted to the base station in response to the PDSCH transmissions.

At act 820, the UE performs SRS Tx power prediction. For example, as described with reference to FIG. 5. The SRS may be transmitted by the UE using a first frequency band, for example, as described with reference to FIG. 2 and throughout the present disclosure.

At act 830, the UE checks a channel state information (CSI) configuration and/or a PMI configuration. In some examples, the UE checks if a CSI configuration and/or PMI configuration exists for the frequency band used to transmit SRS. For example, in the context of FIG. 2, the UE may check whether CSI and/or PMI is configured for the first frequency band.

At act 840, the UE determines an impacted bandwidth. For example, the UE may determine a percentage of a total bandwidth that the UE is configured with that is impacted by interference due to SRS antenna switching.

At act 850, the UE performs one or more interference mitigation measures based on the evaluated BLER, the predicted SRS Tx power, the CSI configuration, the PMI configuration, and/or the determined impacted bandwidth.

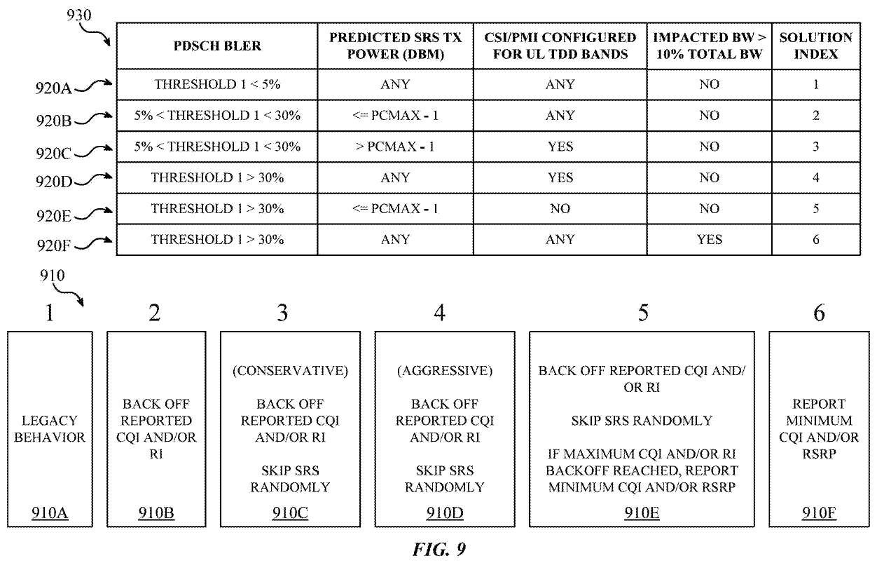

FIG. 9 is a schematic diagram illustrating an example of DL throughput focused interference mitigation measures 910A-910F (collectively referred to as “interference mitigation measures 910”). In some aspects, one or more of the interference mitigation measures 910 are performed by a UE (e.g., UE 101), for example, at act 850 of FIG. 8.

In some aspects, the UE selects one or more of the interference mitigation measures 910 based on a set of conditions 920A-920F (collectively referred to as “conditions 920”) included in a condition table 930. As shown, the conditions may include conditions for PDSCH BLER, SRS Tx power, CSI/PMI configuration, and/or impacted bandwidth. The conditions 920 may correspond to a plurality of respective solution indexes, which may each correspond to one of the interference mitigation measures 910.

In some aspects, evaluating a PDSCH BLER condition includes evaluating a first BLER threshold value, referred to as “THRESHOLD 1”, as previously described. The first BLER threshold value may be determined based on a difference between PDSCH BLER on slots overlapping SRS transmissions and PDSCH BLER on slots not overlapping SRS transmission.

In some aspects, evaluating the predicted SRS Tx power condition includes comparing the predicted SRS Tx power to an SRS threshold value. The SRS threshold value, for example, may be determined relative to a maximum SRS Tx power, referred to as “PCMAX”.

The interference mitigation measure 910A may include a legacy UE behavior. The interference mitigation measure 910A may be performed, for example, in response to the condition 920A being satisfied. As shown, the condition 920A includes the first BLER threshold being less than a first percentage value (e.g., 5%), and an impacted bandwidth being less than a threshold percentage of total bandwidth (e.g., 10%). If the condition 920A is satisfied, the UE may determine that further interference mitigation in addition to the legacy behavior is not desired.

The interference mitigation measure 910B may include backing off an a reported CQI value and/or backing off on a reported RI value, for example, as described with reference to FIGS. 1-2 and FIG. 7. The UE may back off on a reported CQI value according to a CQI backoff step size until a CQI threshold is reached. Upon reaching the CQI threshold, the UE may back off on a report RI value according to an RI backoff step size until an RI threshold is reached.

The interference mitigation measure 910B may be performed in response to the condition 920B being satisfied. As shown, the condition 920B includes the first BLER threshold being greater than the first percentage value (e.g., 5%) and less than a second percentage value (e.g., 30%). Furthermore, the condition 920B includes the predicted SRS Tx power being less than or equal to a first SRS threshold value, and the impacted bandwidth being less than the threshold percentage of the total bandwidth (e.g., 10%). In the illustrated example, the first SRS threshold value is equal to (PCMAX−1) dBm.

The interference mitigation measures 910C-910D may include backing off on a reported CQI value and/or backing off on a reported RI value, and skipping SRS transmissions randomly. In some aspects, the interference mitigation measure 910C corresponds to a conservative approach, and the interference mitigation measure 910D corresponds to an aggressive approach. A CQI backoff step size and/or an RI backoff step size used for the interference mitigation measure 910D may be greater than a CQI backoff step size and/or an RI backoff step size used for the interference mitigation measure 910C. As an example, a CQI backoff step size of 3 may be used for the interference mitigation measure 910D, and a CQI backoff step size of 1 may be used for the interference mitigation measure 910C. Furthermore, the interference mitigation measure 910D may include skipping a larger number of SRS transmissions than the interference mitigation measure 910C. In some examples, the interference mitigation measure 910C includes randomly skipping a first percentage of SRS transmissions, and the interference mitigation measure 910D includes skipping a second percentage of SRS transmissions, the second percentage being greater than the first percentage. For example, the first percentage may be equal to THRESHOLD 1, and the second percentage may be equal to THRESHOLD 1 times a multiplier (e.g., THRESHOLD 1*2).

The interference mitigation measure 910C may be performed in response to the condition 920C being satisfied. As shown, the condition 920C includes the first BLER threshold being greater than the first percentage value (e.g., 5%) and less than the second percentage value (e.g., 30%). Furthermore, the condition 920C includes the predicted SRS Tx power being greater than the first SRS threshold value (e.g., PCMAX−1), CSI and PMI being configured for UL TDD bands, and the impacted bandwidth being less than the threshold percentage of the total bandwidth (e.g., 10%). The UL TDD bands, for example, may be used to transmit SRS using antenna switching.

The interference mitigation measure 910D may be performed in response to the condition 920D being satisfied. As shown, the condition 920D includes the first BLER threshold being greater than the second percentage value, CSI and PMI being configured for UL TDD bands, and the impacted bandwidth being less than the threshold percentage of the total bandwidth (e.g., 10%).

The interference mitigation measure 910E may include backing off an a reported CQI and/or RI value, and skipping SRS transmissions randomly. In some aspects, the backing off the reported CQI and/or RI value and skipping SRS transmissions in the interference mitigation measure 910E corresponds to the aggressive approach (e.g., greater backoff step size and/or percentage of skipped SRS). The interference mitigation measure 910E may further include, if a maximum CQI and/or RI backoff is reached, reporting a minimum CQI and/or RSRP value, for example, as described with reference to FIGS. 1-2 and throughout the present disclosure. In some examples, a maximum CQI backoff is reached upon backing off to a CQI value of 1, and a maximum RI backoff is reached upon backing off to a rank value of 1.

The interference mitigation measure 910E may be performed in response to the condition 920E being satisfied. As shown, the condition 920E includes the first BLER threshold being greater than the second percentage value (e.g., 30%), the predicted SRS Tx power being less than or equal to the first SRS threshold value (e.g., PCMAX−1), CSI and PMI not being configured for UL TDD bands, and the impacted bandwidth being less than the threshold percentage of the total bandwidth (e.g., 10%).

The interference mitigation measure 910F may include reporting a minimum CQI value and/or reporting a minimum RSRP value, as previously described. The interference mitigation measure 910F may be performed in response to the condition 920F being satisfied. As shown, the condition 920F includes the first BLER threshold being greater than the second percentage value (e.g., 30%), and the impacted bandwidth being greater than the threshold percentage of the total bandwidth (e.g., 10%).

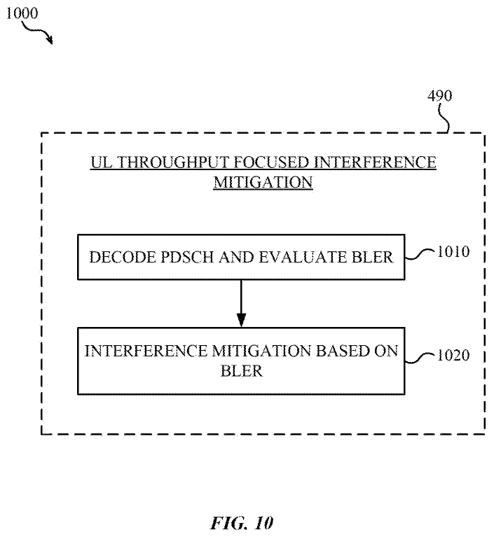

FIG. 10 illustrates an example process flow 1000 for a UE (e.g., UE 101) to perform UL throughput focused interference mitigation. As illustrated in FIG. 10, the process flow 1000 includes an example of act 490 of FIG. 4, which includes acts 1010 and 1020.

At act 1010, the UE decodes PDSCH transmissions from a base station (e.g., base station 111) and evaluates BLER. The PDSCH transmissions may be received by the UE using a second frequency band, for example, as described with reference to FIG. 2. In some examples, the BLER is evaluated based on a ratio of ACK to NACK messages transmitted to the base station in response to the PDSCH transmissions.

At act 1020, the UE performs one or more interference mitigation measures based on the evaluated BLER.

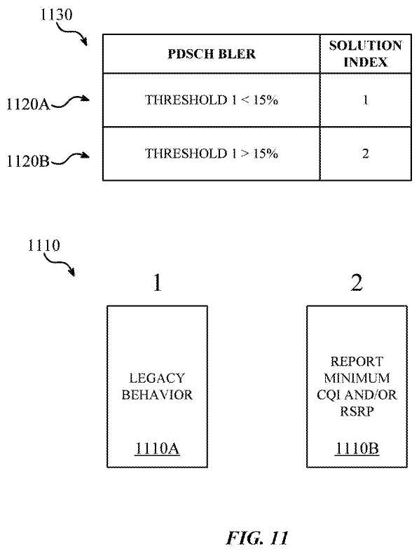

FIG. 11 is a schematic diagram illustrating an example of UL throughput focused interference mitigation measures 1110A, 1110D (collectively referred to as “interference mitigation measures 1110”). In some aspects, one or more of the interference mitigation measures 1110 are performed by a UE (e.g., UE 101), for example, at act 1020 of FIG. 10.

In some aspects, the UE selects one or more of the interference mitigation measures 1110 based on a set of conditions 1120A-1120B (collectively referred to as “conditions 1120”) included in a condition table 1130. As shown, the conditions 1120 may include conditions for PDSCH BLER. The conditions 1120 may correspond to a plurality of respective solution indexes, which may each correspond to one of the interference mitigation measures 1110.

In some aspects, evaluating a PDSCH BLER condition includes evaluating a first BLER threshold value, referred to as “THRESHOLD 1”, as previously described. The first BLER threshold value may be determined based on a difference between PDSCH BLER on slots overlapping SRS transmissions and PDSCH BLER on slots not overlapping SRS transmission.

The interference mitigation measure 1110A may include a legacy UE behavior. The interference mitigation measure 1110A may be performed, for example, in response to the condition 1120A being satisfied. As shown, the condition 1120A includes the first BLER threshold being less than a first percentage value (e.g., 15%). If the condition 1120A is satisfied, the UE may determine that further interference mitigation in addition to the legacy behavior is not desired.

The interference mitigation measure 1110B may include reporting a minimum CQI value and/or reporting a minimum RSRP value, for example, as described with reference to FIGS. 1-2 and throughout the present disclosure. The interference mitigation measure 1110B may be performed in response to the condition 1120B being satisfied. As shown, the condition 1120B includes the first BLER threshold being greater than the first percentage value (e.g., 15%).

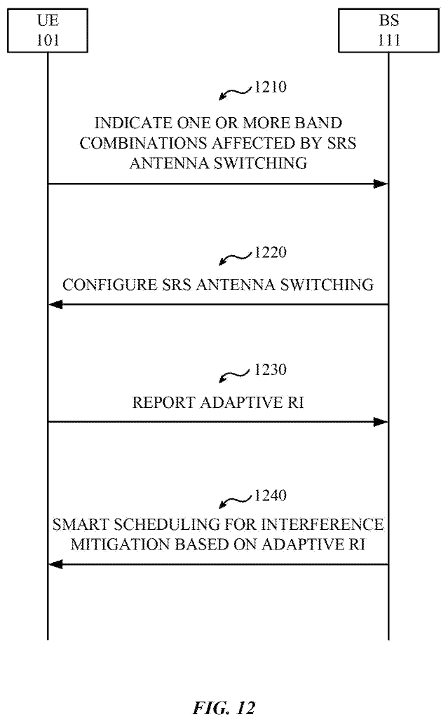

FIG. 12 is a schematic diagram illustrating an example of signaling between a UE 101 and a base station 111. In some aspects, the UE 101 reports an adaptive RI to the base station 111, and the base station 111 performs smart scheduling to mitigate interference related to SRS antenna switching based on the adaptive RI.

At act 1210, the UE 101 indicates one or more band combinations impacted by SRS antenna switching. For example, the UE 101 may transmit UE capability information to the base station 111, and the UE capability information may include an IE txSwitchImpactToRx indicating the impacted band combinations.

At act 1220, the base station 111 configures the UE 101 to perform SRS antenna switching. For example, the base station 111 may transmit an RRC reconfiguration message to the UE 101 to configure the SRS antenna switching.

At act 1230, the UE 101 reports an adaptive RI to the base station 111. The adaptive RI may vary depending on the limitations and/or current radio frequency (RF) conditions of the UE. In some examples, the UE 101 determines the adaptive RI based on one or more of: an estimated rank on slots impacted by SRS antenna switching, an estimated rank on slots not impacted by SRS antenna switching, and a ratio between a number of impacted slots and a total number of slots. For example, the UE may determine the adaptive RI using the following equation:

$${R}_{adaptive} = Floor [ {R}_{normal} * ( 1 - {Ratio}_{impacted} ) + {R}_{impacted} * {Ratio}_{impacted} ]$$

Rₙₒᵣₘₐₗ is the estimated rank on non-impacted slots, R_{impacted} is the estimated rank on impacted slots, and Ratio_{impacted} is the percentage of impacted slots relative to the total number of slots.

At act 1240, the base station 111 performs smart scheduling for interference mitigation based on the adaptive RI and/or BLER. In order to perform smart scheduling, the base station 111 may determine which slots are impacted by SRS antenna switching based on the adaptive RI received from the UE 101. In some examples, the base station 111 detects the adaptive RI, and determines the ratio between the number of impacted slots and the total number of slots (e.g., Ratio_{impacted}) based on the adaptive RI. Further, the base station 111 may determine the impacted slots based on BLER and Ratio_{impacted}. In response to the determination, the base station 111 may begin performing smart scheduling. By using a combination of adaptive RI and BLER, the base station 111 may be able to differentiate between slots with poor BLER due to SRS transmission, and slots with poor BLER due to poor RF conditions in general or other factors.

In some examples, the base station 111 schedules a lower number of layers (e.g., fewer MIMO data streams) on the impacted slots, and a higher number of layers (e.g., more MIMO data streams) on the non-impacted slots. Alternatively, the base station 111 may avoid scheduling the UE 101 during the impacted slots, and only schedule the non-impacted slots.

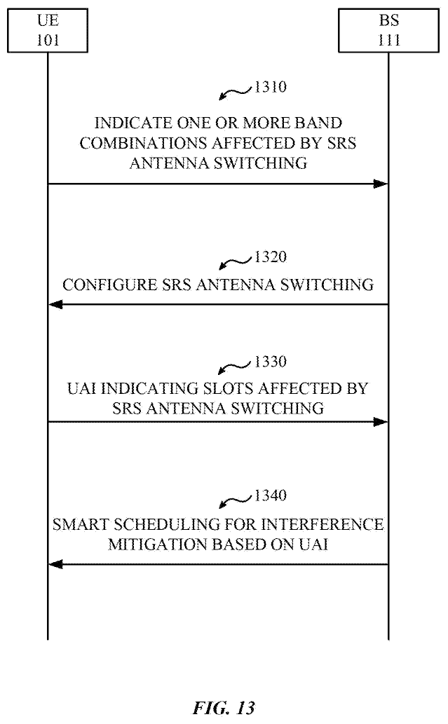

FIG. 13 is a schematic diagram illustrating an example of signaling between a UE 101 and a base station 111. In some aspects, the UE 101 transmits UE assistance information (UAI) to the base station 111 indicating one or more slots impacted by SRS antenna switching, and the base station 111 performs smart scheduling to mitigate interference related to SRS antenna switching based on the UAI.

At act 1310, the UE 101 indicates one or more band combinations impacted by SRS antenna switching. For example, the UE 101 may transmit UE capability information to the base station 111, and the UE capability information may include an IE txSwitchImpactToRx indicating the impacted band combinations.

At act 1320, the base station 111 configures the UE 101 to perform SRS antenna switching. For example, the base station 111 may transmit an RRC reconfiguration message to the UE 101 to configure the SRS antenna switching.

At act 1330, the UE transmits UAI to the base station 111. In some aspects, the UAI indicates one or more resources impacted by the SRS antenna switching. For example, the UAI may indicate a list of frequency bands impacted by the antenna switching, or a list of slots impacted by the antenna switching on the frequency bands. In some aspects, the UAI indicates one or more preferences of the UE 101 related to the SRS antenna switching. For example, the UAI may indicate one or more preferred layers (e.g., MIMO data streams) on each of the one or more slots impacted by the antenna switching. Additionally or alternatively, the UAI may indicate that PMI is preferred when an RSRP value is greater than a first RSRP threshold, SRS is preferred when the RSRP value is greater than a second RSRP threshold, or an indication to use PMI only when the RSRP is less than a third RSRP threshold value. The RSRP value, for example, may be the RSRP value of the base station 111 (e.g., a serving cell). For example, the UE 101 may receive DL reference signals (e.g., synchronization signal block (SSB), channel state information reference signal (CSI-RS), etc.), and determine the RSRP by measuring the DL reference signals. In some examples, the second RSRP threshold is greater than the first RSRP threshold. In some examples, the third RSRP threshold is less than or equal to the first RSRP threshold.

At act 1340, the base station 111 performs smart scheduling for interference mitigation based on the UAI. In some examples, the base station 111 avoids scheduling the UE 101 during slots impacted by antenna switching, and only schedules the UE 101 during non-impacted slots Additionally or alternatively, the base station 111 may schedule the UE 101 according to the preferences indicated in the UAI. For example, the base station 111 may schedule preferred layers during the impacted slots according to the UAI.

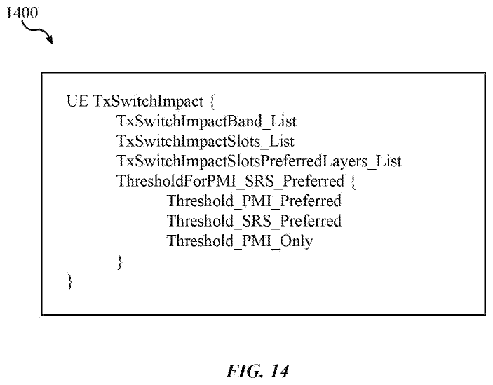

FIG. 14 illustrates an example of an IE 1400, e.g., named UE TxSwitchImpact that may be included in the UAI of FIG. 13.

The IE 1400 may include a first parameter, e.g., named TxSwitchImpactBand_List, which may indicate one or more frequency bands impacted by SRS antenna switching.

The IE 1400 may include a second parameter, e.g., named TxSwitchImpactSlots_List, which may indicate one or more slots impacted by SRS antenna switching on each of the impacted bands.

The IE 1400 may include a third parameter, e.g., named TxSwitchImpactSlotsPreferredLayers_List, which may indicate one or more preferred layers (e.g., MIMO data streams) to be used for the impacted slots.

The IE 1400 may include a fourth parameter, e.g., named ThresholdForPMI_SRS Preferred, which may indicate preferences of the UE related to PMI and/or SRS. In some examples, the fourth parameter indicates one or more thresholds, and the UE prefers to use SRS or PMI based on a measurement (e.g., RSRP) value relative to the one or more thresholds. Additionally or alternatively, the UE may use PMI only based on the measurement value relative to the one or more thresholds. For example, the fourth parameter may include first, second, and third sub-parameters indicating first, second, and third thresholds respectively.

The first sub-parameter, e.g., named Threshold_PMI Preferred may indicate a first RSRP threshold. When the first RSRP threshold is exceeded, the UE may prefer to use PMI.

The second sub-parameter, e.g., named Threshold_SRS Preferred may indicate a second RSRP threshold. When the second RSRP threshold is exceeded, the UE may prefer to use SRS.

The third sub-parameter, e.g., named Threshold_PMI Only may indicate a third RSRP threshold. When an RSRP is less than the third RSRP threshold, the UE may use PMI only. In some examples, a low RSRP may be indicative of poor RF conditions. The UE may transmit PMI to a base station (e.g., base station 111), which may utilize the PMI to estimate the channel. In some examples, using PMI (e.g., instead of SRS) to estimate the channel may be more efficient when operating in poor RF conditions.

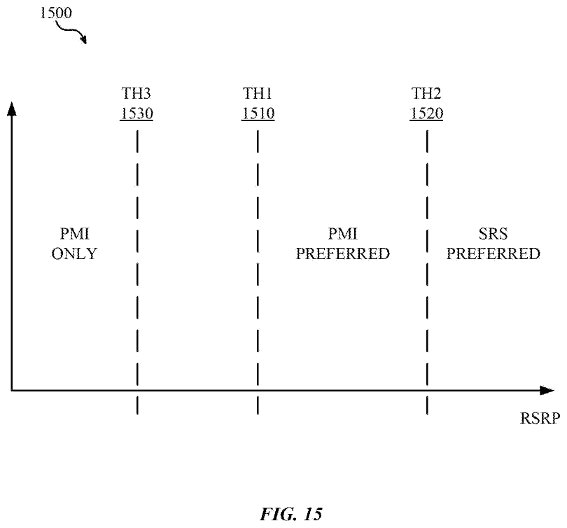

FIG. 15 illustrates an example 1500 of RSRP threshold values. Illustrated is a first RSRP threshold value 1510, a second RSRP threshold value 1520, and a third RSRP threshold value 1530. A UE (e.g., UE 101) may measure RSRP of reference signals received from a base station (e.g., base station 111). When the measured RSRP (illustrated by the x-axis) is greater than the first RSRP threshold value 1510, the UE may prefer to use PMI. When the measured RSRP is greater than the second RSRP threshold value 1520, the UE may prefer to use SRS. When the measured RSRP is less than the third RSRP threshold value 1530, the UE may use PMI only. In some examples, when both the first and second RSRP threshold values 1510, 1520 are exceeded, the network (e.g., base station 111) decides whether to use PMI or SRS based on its own preference and/or other factors.

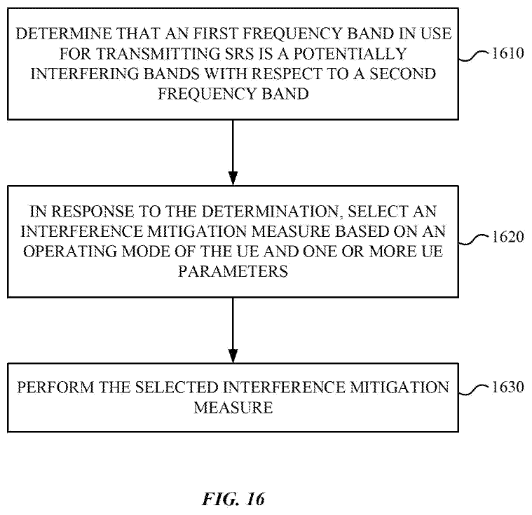

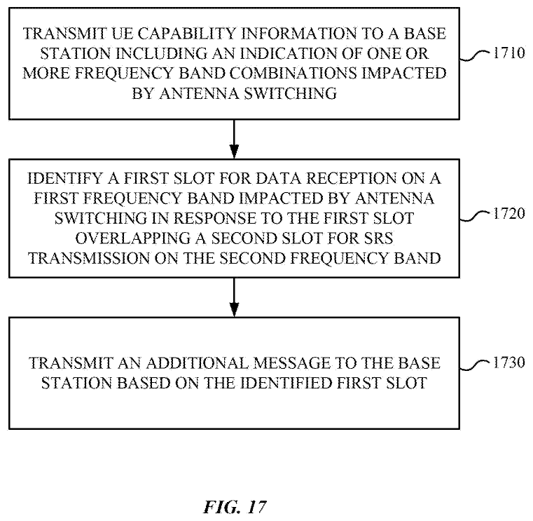

FIGS. 16-17 are example process flows for UEs configured to perform interference mitigation measures in accordance with some aspects of the present disclosure. The UEs may be the UE 101, as described throughout the present disclosure.

With reference to FIG. 16, at act 1610, the UE determines that a first frequency band in use for transmitting SRS is a potentially interfering band with respect to a second frequency band. The first and second frequency bands, for example, may be the first and second frequency bands as described with reference to FIG. 2 and throughout the present disclosure.

At act 1620, in response to the determination, the UE selects an interference mitigation measure based on an operating mode of the UE and one or more UE parameters, for example, as described with reference to FIG. 1 and throughout the present disclosure.

At act 1630, the UE performs the selected interference mitigation measure.

With reference to FIG. 17, at act 1710, the UE transmits UE capability information to a base station (e.g., base station 111). The UE capability information includes an indication of one or more frequency band combinations impacted by antenna switching, for example, as described with reference to FIGS. 3, 12, 13, and throughout the present disclosure. The antenna switching may be associated with transmission of SRS, as previously described. The one or more frequency band combinations may comprise a first frequency band combination including a first frequency band and a second frequency band.

At act 1720, the UE identifies a first slot for data reception on the first frequency band impacted by antenna switching in response to the first slot overlapping a second slot for SRS transmission on the second frequency band. In some examples, identifying the first slot is further in response to a determination that SRS antenna switching is configured.

At act 1730, the UE transmits an additional message to the base station based on the identified first slot. For example, the UE may transmit adaptive RI to the base station based on the identified slot (e.g., as in FIG. 12), or transmit UAI to the base station based on the identified slot (e.g., as in FIG. 13).

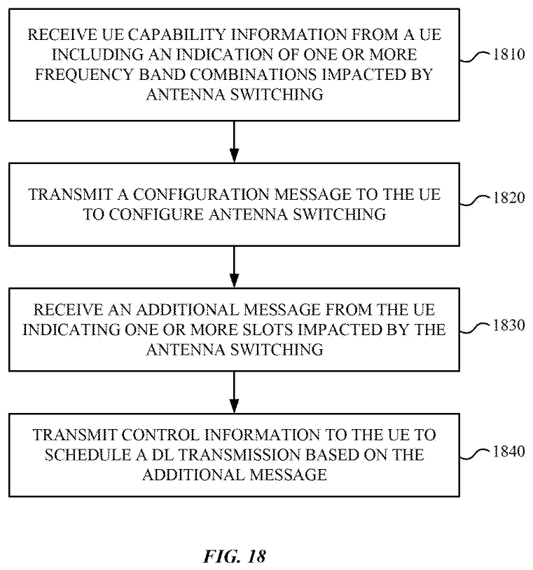

FIG. 18 is an example process flow for a base station (e.g., base station 111) to perform smart slot scheduling for interference mitigation in accordance with some aspects of the present disclosure.

At act 1810, the base station receives UE capability information from a UE (e.g., UE 101). The UE capability information includes an indication of one or more frequency band combinations impacted by antenna switching, for example, as described with reference to FIGS. 3, 12, 13, and throughout the present disclosure. The antenna switching may be associated with transmission of SRS, as previously described.

At act 1820, the base station transmits a configuration message to the UE to configure the SRS antenna switching. In some examples, the configuration message comprises an RRC reconfiguration message.

At act 1830, the base station receives an additional message from the UE indicating one or more slots impacted by the antenna switching. The additional message, for example, may comprise an adaptive RI (e.g., as in FIG. 12), or UAI (e.g., as in FIG. 13).

At act 1840, the base station transmits control information to the UE to schedule a DL transmission based on the additional message. For example, the base station may perform smart scheduling by scheduling the UE during slots not impacted by SRS antenna switching. If the additional message includes UAI, the UAI may also include one or more preferences of the UE, and the base station may schedule the UE according to the one or more preferences.

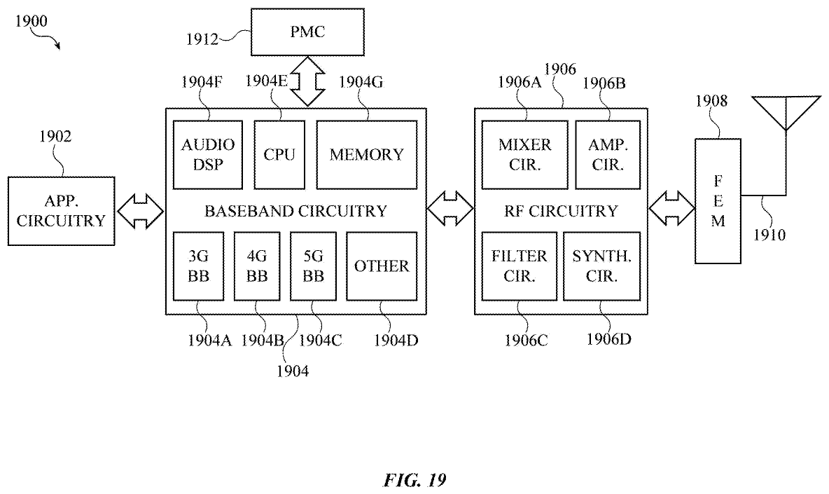

FIG. 19 is a diagram illustrating example components of a device 1900 that can be employed in accordance with some aspects of the present disclosure. In some aspects, the device 1900 can include application circuitry 1902, baseband circuitry 1904, RF circuitry 1906, front-end module (FEM) circuitry 1908, one or more antennas 1910, and power management circuitry (PMC) 1912 coupled together at least as shown. The components of the illustrated device 1900 can be included in a UE or a RAN node such as the UE 101 or the base station 111 as described throughout the present disclosure. The UE 101 and/or the base station 111 may be configured to perform interference mitigation measures to mitigate SRS antenna switching related interference, as described throughout the present disclosure. In some implementations, the device 1900 can include fewer elements (e.g., a RAN node may not utilize application circuitry 1902 and instead include a processor/controller to process IP data received from a CN, which may be a 5GC or an Evolved Packet Core (EPC)). In some implementations, the device 1900 can include additional elements such as, for example, memory/storage, display, camera, sensor (including one or more temperature sensors, such as a single temperature sensor, a plurality of temperature sensors at different locations in device 1900, etc.), or input/output (I/O) interface. In other implementations, the components described below can be included in more than one device (e.g., said circuitries can be separately included in more than one device for Cloud-RAN (C-RAN) implementations).

The application circuitry 1902 can include one or more application processors. For example, the application circuitry 1902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1900. In some implementations, processors of application circuitry 1902 can process IP data packets received from an EPC.

The baseband circuitry 1904 can include circuitry such as, but not limited to, one or more single-core or multi-core processors. The baseband circuitry 1904 can include one or more baseband processors or control logic to process baseband signals received from a receive signal path of the RF circuitry 1906 and to generate baseband signals for a transmit signal path of the RF circuitry 1906. Baseband circuitry 1904 can interface with the application circuitry 1902 for generation and processing of the baseband signals and for controlling operations of the RF circuitry 1906. For example, in some implementations, the baseband circuitry 1904 can include a 3G baseband processor 1904A, a 4G baseband processor 1904B, a 5G baseband processor 1904C, or other baseband processor(s) 1904D for other existing generations, generations in development or to be developed in the future (e.g., 2G, 6G, etc.).

The baseband circuitry 1904 (e.g., one or more of baseband processors 1904A-D) can handle various radio control functions that enable communication with one or more radio networks via the RF circuitry 1906. In other implementations, some or all of the functionality of baseband processors 1904A-D can be included in modules stored in the memory 1904G and executed via a Central Processing Unit (CPU) 1904E. The radio control functions can include, but are not limited to, signal modulation/demodulation, encoding/decoding, radio frequency shifting, etc. In some implementations, the baseband circuitry 1904 can include one or more audio digital signal processor(s) (DSP) 1904F.

RF circuitry 1906 can enable communication with wireless networks using modulated electromagnetic radiation through a non-solid medium. In various implementations, the RF circuitry 1906 can include switches, filters, amplifiers, etc. to facilitate the communication with the wireless network. RF circuitry 1906 can include a receive signal path which can include circuitry to down-convert RF signals received from the FEM circuitry 1908 and provide baseband signals to the baseband circuitry 1904. RF circuitry 1906 can also include a transmit signal path which can include circuitry to up-convert baseband signals provided by the baseband circuitry 1904 and provide RF output signals to the FEM circuitry 1908 for transmission.

In some implementations, the receive signal path of the RF circuitry 1906 can include mixer circuitry 1906A, amplifier circuitry 1906B and filter circuitry 1906C. In some implementations, the transmit signal path of the RF circuitry 1906 can include filter circuitry 1906C and mixer circuitry 1906A. RF circuitry 1906 can also include synthesizer circuitry 1906D for synthesizing a frequency for use by the mixer circuitry 1906A of the receive signal path and the transmit signal path.

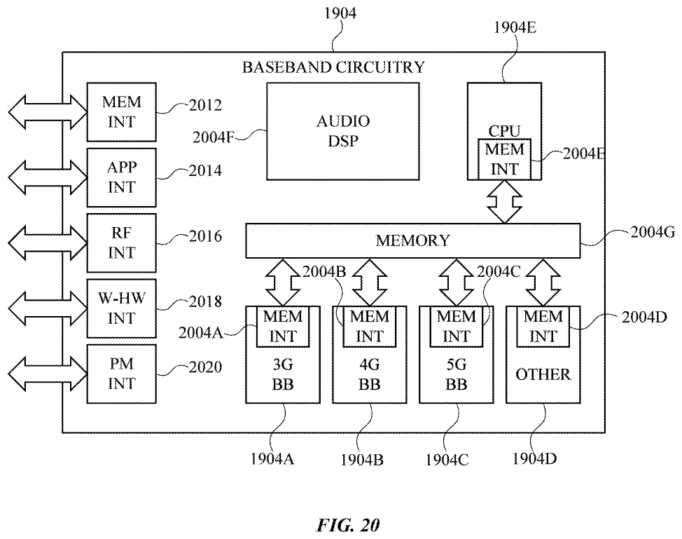

FIG. 20 illustrates a diagram illustrating example interfaces of baseband circuitry that can be employed in accordance with some aspects. As discussed above, the baseband circuitry 1904 of FIG. 19 can comprise processors 1904A-1904E and a memory 1904G utilized by said processors. Each of the processors 1904A-1904E can include a memory interface, 2004A-2004E, respectively, to send/receive data to/from the memory 1904G. The baseband circuitry 1904, or the one or more baseband processors or control logic of the baseband circuitry 1904, may stand alone as the UE 101 or the base station 111 and perform signaling and operation in the meaning as described throughout this disclosure.

The baseband circuitry 1904 can further include one or more interfaces to communicatively couple to other circuitries/devices, such as a memory interface 2012 (e.g., an interface to send/receive data to/from memory external to the baseband circuitry 1904), an application circuitry interface 2014 (e.g., an interface to send/receive data to/from the application circuitry 1902 of FIG. 19), an RF circuitry interface 2016 (e.g., an interface to send/receive data to/from RF circuitry 1906 of FIG. 19), a wireless hardware connectivity interface 2018 (e.g., an interface to send/receive data to/from Near Field Communication (NFC) components, Bluetooth® components (e.g., Bluetooth® Low Energy), Wi-Fi® components, and other communication components), and a power management interface 2020 (e.g., an interface to send/receive power or control signals to/from the PMC 1912).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a baseband processor of a user equipment (UE). The baseband processor comprises one or more configured to execute instructions stored in a memory to cause the UE to: determine that a first frequency band in use for transmitting sounding reference signals (SRS) is a potentially interfering band with respect to a second frequency band, in response to the determination, select an interference mitigation measure based on an operating mode of the UE and one or more UE parameters, and perform the selected interference mitigation measure.

Example 2 comprises the subject matter of any variation of example 1, wherein the one or more processors further cause the UE to: transmit UE capability information that indicates that the combination of the first and second frequency bands impacts receiving quality, wherein the determination that the first frequency band in use for transmitting SRS is a potentially interfering band with respect to the second frequency band is based on the UE capability information.

Example 3 comprises the subject matter of any variation of example 2, wherein selecting the interference mitigation measure is further in response to receiving an SRS antenna switching configuration.

Example 4 comprises the subject matter of any variation of example 1, wherein the operating mode of the UE includes an ultra-reliable low latency communications (URLLC) operating mode, and wherein the one or more processors further cause the UE to: determine the operating mode of the UE based on one or more of: a packet delay budget, a packet error rate, a configured UL grant, a bandwidth part (BWP) configured slot length, a duplicated packet data convergence protocol (PDCP), a low spectral efficiency modulation and coding scheme (MCS) table, a slot repetition, a configuration of mini-slots, a configuration of pre-emptive downlink control information (DCI), an active extended reality (XR) or vehicle to everything (V2X) application, a low latency required flag, and a high reliability flag.

Example 5 comprises the subject matter of any variation of example 1, wherein the one or more processors further cause the UE to: determine the operating mode of the UE based on a ratio of uplink (UL) to downlink (DL) throughput.

Example 6 comprises the subject matter of any variation of example 1, wherein performing the selected interference mitigation measure includes backing off on a reported channel quality indicator (CQI) value until a CQI threshold value is reached.

Example 7 comprises the subject matter of any variation of example 6, wherein performing the selected interference mitigation measure further includes backing off on a reported rank indicator (RI) value until a RI threshold value is reached.

Example 8 comprises the subject matter of any variation of example 1, wherein performing the selected interference mitigation measure includes reporting one or more of: a minimum channel quality indicator (CQI) value, and a minimum reference signal received power (RSRP) value.

Example 9 comprises the subject matter of any variation of example 1, wherein performing the selected interference mitigation measure includes skipping an SRS transmission in response to a slot for the SRS transmission overlapping one of: a slot for a configured DL grant, a slot for slot repetition, a mini-slot, or a slot for pre-empted DL.

Example 10 comprises the subject matter of any variation of example 1, wherein performing the selected interference mitigation measure includes skipping an SRS transmission randomly based on a block error rate (BLER) of a DL channel.

Example 11 comprises the subject matter of any variation of example 1, wherein performing the selected interference mitigation measure further includes skipping antenna switching associated with the SRS.

Example 12 comprises the subject matter of any variation of example 1, wherein the one or more UE parameters include one or more of: a physical downlink shared channel (PDSCH) block-error rate (BLER) associated with the second frequency band, a predicted SRS transmit power, a channel state information (CSI) configuration for the first frequency band, a precoding matrix indicator (PMI) configuration for the first frequency band, and a percentage of a total bandwidth impacted by the interference.

Example 13 comprises the subject matter of any variation of example 1, wherein the first frequency band is a time division duplex (TDD) frequency band, and wherein the second frequency band is a frequency division duplex (FDD) frequency band.

Example 14 is a baseband processor of a user equipment (UE). The baseband processor comprises one or more configured to execute instructions stored in a memory to cause the UE to: transmit UE capability information to a base station, the UE capability information including an indication of one or more frequency band combinations impacted by antenna switching associated with transmission of sounding reference signals (SRS), wherein the one or more frequency band combinations includes a first frequency band combination including a first frequency band and a second frequency band, identify a first slot for data reception on the first frequency band impacted by the antenna switching in response to the first slot overlapping a second slot for SRS transmission on the second frequency band, and transmit an additional message to the base station based on the identified first slot.

Example 15 comprises the subject matter of any variation of example 14, wherein the one or more processors further cause the UE to: determine an adaptive rank indicator (RI) value based on one or more of: an estimated rank on slots impacted by the antenna switching, an estimated rank on slots not impacted by the antenna switching, and a ratio between a number of slots impacted by the antenna switching and a number of slots not impacted by the antenna switching, wherein the additional message indicates the adaptive RI value.

Example 16 comprises the subject matter of any variation of example 14, wherein the additional message includes UE assistance information (UAI).

Example 17 comprises the subject matter of any variation of example 16, wherein the UAI includes one or more of: a list of frequency bands impacted by the antenna switching, a list of slots impacted by the antenna switching on the frequency bands, a list of preferred layers on the slots impacted by the antenna switching, an indication that precoding matrix indicator (PMI) is preferred when a reference signal received power (RSRP) is greater than a first threshold value, an indication that SRS is preferred when the RSRP is greater than a second threshold value, an indication to use PMI only when the RSRP is greater than a third threshold value.

Example 18 is a method to be performed by a base station. The method comprises: receiving user equipment (UE) capability information from a UE, the UE capability information including an indication of one or more frequency band combinations impacted by antenna switching associated with transmission of sounding reference signals (SRS), transmitting a configuration message to the UE to configure SRS antenna switching, receiving an additional message from the UE indicating one or more slots impacted by the SRS antenna switching, and transmitting control information to the UE to schedule a DL transmission based on the additional message.

Example 19 comprises the subject matter of any variation of example 18, wherein the additional message comprises an adaptive rank indicator (RI) value indicating that UE receiving quality is impacted during the one or more slots by the SRS antenna switching.

Example 20 comprises the subject matter of any variation of example 18, wherein the additional message comprises UE assistance information (UAI) including one or more of: one or more frequency bands impacted by the antenna switching, one or more slots impacted by the antenna switching on the one or more frequency bands, one or more preferred layers on each of the one or more slots impacted by the antenna switching, an indication that precoding matrix indicator (PMI) is preferred when a reference signal received power (RSRP) is greater than a first threshold value, an indication that SRS is preferred when the RSRP is greater than a second threshold value, an indication to use PMI only when the RSRP is greater than a third threshold value.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A baseband processor of a user equipment (UE), comprising:
one or more processors configured to execute instructions stored in a memory to cause the UE to:
determine that a first frequency band in use for transmitting sounding reference signals (SRS) is a potentially interfering band with respect to a second frequency band;
in response to the determination, select an interference mitigation measure based on an operating mode of the UE and one or more UE parameters; and
perform the selected interference mitigation measure.

2. The baseband processor of claim 1, wherein the one or more processors further cause the UE to:
transmit UE capability information that indicates that the combination of the first and second frequency bands impacts receiving quality, wherein the determination that the first frequency band in use for transmitting SRS is a potentially interfering band with respect to the second frequency band is based on the UE capability information.

3. The baseband processor of claim 2, wherein selecting the interference mitigation measure is further in response to receiving an SRS antenna switching configuration.

4. The baseband processor of claim 1, wherein the operating mode of the UE includes an ultra-reliable low latency communications (URLLC) operating mode, and wherein the one or more processors further cause the UE to:
determine the operating mode of the UE based on one or more of: a packet delay budget, a packet error rate, a configured UL grant, a bandwidth part (BWP) configured slot length, a duplicated packet data convergence protocol (PDCP), a low spectral efficiency modulation and coding scheme (MCS) table, a slot repetition, a configuration of mini-slots, a configuration of pre-emptive downlink control information (DCI), an active extended reality (XR) or vehicle to everything (V2X) application, a low latency required flag, and a high reliability flag.

5. The baseband processor of claim 1, wherein the one or more processors further cause the UE to:
determine the operating mode of the UE based on a ratio of uplink (UL) to downlink (DL) throughput.

6. The baseband processor of claim 1, wherein performing the selected interference mitigation measure includes backing off on a reported channel quality indicator (CQI) value until a CQI threshold value is reached.

7. The baseband processor of claim 6, wherein performing the selected interference mitigation measure further includes backing off on a reported rank indicator (RI) value until a RI threshold value is reached.

8. The baseband processor of claim 1, wherein performing the selected interference mitigation measure includes reporting one or more of:
a minimum channel quality indicator (CQI) value; and
a minimum reference signal received power (RSRP) value.

9. The baseband processor of claim 1, wherein performing the selected interference mitigation measure includes skipping an SRS transmission in response to a slot for the SRS transmission overlapping one of: a slot for a configured DL grant, a slot for slot repetition, a mini-slot, or a slot for pre-empted DL.

10. The baseband processor of claim 1, wherein performing the selected interference mitigation measure includes skipping an SRS transmission randomly based on a block error rate (BLER) of a DL channel.

11. The baseband processor of claim 10, wherein performing the selected interference mitigation measure further includes skipping antenna switching associated with the SRS.

12. The baseband processor of claim 1, wherein the one or more UE parameters include one or more of:
a physical downlink shared channel (PDSCH) block-error rate (BLER) associated with the second frequency band;
a predicted SRS transmit power;
a channel state information (CSI) configuration for the first frequency band;
a precoding matrix indicator (PMI) configuration for the first frequency band; and
a percentage of a total bandwidth impacted by the interference.

13. The baseband processor of claim 1, wherein the first frequency band is a time division duplex (TDD) frequency band, and wherein the second frequency band is a frequency division duplex (FDD) frequency band.

14. A baseband processor of a user equipment (UE), comprising:
one or more processors configured to execute instructions stored in a memory to cause the UE to:
transmit UE capability information to a base station, the UE capability information including an indication of one or more frequency band combinations impacted by antenna switching associated with transmission of sounding reference signals (SRS), wherein the one or more frequency band combinations includes a first frequency band combination including a first frequency band and a second frequency band;
identify a first slot for data reception on the first frequency band impacted by the antenna switching in response to the first slot overlapping a second slot for SRS transmission on the second frequency band; and
transmit an additional message to the base station based on the identified first slot.

15. The baseband processor of claim 14, wherein the one or more processors further cause the UE to:
determine an adaptive rank indicator (RI) value based on one or more of: an estimated rank on slots impacted by the antenna switching, an estimated rank on slots not impacted by the antenna switching, and a ratio between a number of slots impacted by the antenna switching and a number of slots not impacted by the antenna switching;
wherein the additional message indicates the adaptive RI value.

16. The baseband processor of claim 14, wherein the additional message includes UE assistance information (UAI).

17. The baseband processor of claim 16, wherein the UAI includes one or more of:
a list of frequency bands impacted by the antenna switching;
a list of slots impacted by the antenna switching on the frequency bands;
a list of preferred layers on the slots impacted by the antenna switching;
an indication that precoding matrix indicator (PMI) is preferred when a reference signal received power (RSRP) is greater than a first threshold value;
an indication that SRS is preferred when the RSRP is greater than a second threshold value; and
an indication to use PMI only when the RSRP is greater than a third threshold value.

18. A method to be performed by a base station, comprising:
receiving user equipment (UE) capability information from a UE, the UE capability information including an indication of one or more frequency band combinations impacted by antenna switching associated with transmission of sounding reference signals (SRS);
transmitting a configuration message to the UE to configure SRS antenna switching;
receiving an additional message from the UE indicating one or more slots impacted by the SRS antenna switching; and
transmitting control information to the UE to schedule a DL transmission based on the additional message.

19. The method of claim 18, wherein the additional message comprises an adaptive rank indicator (RI) value indicating that UE receiving quality is impacted during the one or more slots by the SRS antenna switching.

20. The method of claim 18, wherein the additional message comprises UE assistance information (UAI) including one or more of:
one or more frequency bands impacted by the antenna switching;
one or more slots impacted by the antenna switching on the one or more frequency bands;
one or more preferred layers on each of the one or more slots impacted by the antenna switching;
an indication that precoding matrix indicator (PMI) is preferred when a reference signal received power (RSRP) is greater than a first threshold value;
an indication that SRS is preferred when the RSRP is greater than a second threshold value; and
an indication to use PMI only when the RSRP is greater than a third threshold value.
